(19) United States
(12) Patent Application Publication
(10) Pub. No.: US 2003/0131349 A1
(43) Pub. Date: Jul. 10, 2003

(54) Methods and systems for managing and collecting impulse pay-per-view data in smart card enabled television terminals

(75) Inventor: Jeffrey D. Kuczynski-Brown, Elkins Park, PA (US)

Correspondence Address: LAW OFFICE OF BARRY R LIPSITZ, 755 MAIN STREET, MONROE, CT, 06468, US

(73) Assignee: General Instrument Corporation, Horsham, PA

(21) Appl. No.: 10/038,707

(22) Filed: Jan. 4, 2002

(51) Int. Cl. H04N 7/16; H04N 5/445; H04N 7/173

(52) U.S. Cl. 725/6; 725/1; 725/61; 725/104

(57) ABSTRACT

Methods and apparatus for managing and collecting impulse pay-per-view (IPPV) data in smart card enabled digital television terminals are provided. A headend controller sends security information to the terminal for use by the smart card. Authentication data based on the security information is computed by the smart card. The controller polls the terminal to retrieve the authentication data and current IPPV data from the smart card. Current IPPV data is validated by the controller based on the authentication data. Upon validation of the current IPPV data, updated IPPV data is sent from the controller to the smart card via the terminal.

The present invention also enables a purchase report back message to be constructed at the terminal at the time of an initial IPPV purchase, rather than at the time of the poll from the controller. The purchase report back message may be updated at the time of each subsequent IPPV purchase after the initial purchase.

### BACKGROUND OF THE INVENTION

The present invention relates generally to the provision of television services on a pay-per-view basis. More specifically, the present invention relates to methods and apparatus for managing and collecting impulse pay-per-view data in smart card enabled television terminals (e.g., digital consumer set-top television terminals and similar devices).

The capability to make impulse pay-per-view (IPPV) purchases is a paid-for privilege allocated to a subscriber by, for example, a conditional access cable television system operator through the cable television plant headend. As an example, in a cable television plant, a security sub-system within the television terminal is notified of the allocation of this privilege (i.e. that the terminal is provisioned for IPPV). Even though the terminal is provisioned for IPPV, the security sub-system within the terminal must grant each IPPV purchase requested by the subscriber.

The granting of the purchase, even when IPPV privileges are allocated, depends upon the subscriber's current credit status, which is managed for the system operator by the headend controller. The credit status for the subscriber is stored within the security sub-system of the terminal, whether that terminal employs an internal conditional access sub-system (CAS) or an external CAS (i.e. a smart card). Therefore, whenever a subscriber requests an IPPV purchase, the security sub-system of the terminal will allow the purchase (i.e. decrypt the requested event or program) only if it is holding sufficient unused credit for the subscriber. If the subscriber's debit values (also stored within the terminal's security sub-system) are so nearly equal to the credit values that the security sub-system is not holding enough unused credit to cover the cost of the requested program, the security sub-sub-system will disallow the purchase request. Thus, in order to maintain sufficient credit in the terminal's security sub-system (and hence maintain the subscriber's right to make IPPV purchases), the headend controller must continually track the credit and debit values stored in the terminal's security sub-system.

The headend controller will “poll” the terminal, commanding it to “report back” any purchase records the terminal is currently holding. The terminal will not erase the purchase record data until it is commanded to do so by the headend controller. The terminal's response to the purchase poll from the headend controller, i.e., the purchase report back message, consists of two portions. The first portion is the purchase data. Each time an IPPV purchase is ordered by the subscriber and granted by the terminal's security sub-system, data pertaining to that purchase is stored in non-secure memory in the terminal. This data may or may not include authentication data.

Authentication data comprises a set of secure values computed by the security sub-system of the terminal. These secure data values are based on both purchase report back data items and other security information which is supplied to the security sub-system by the headend controller. Authentication data provide the headend controller with a means of verifying and validating the source (the security sub-system) of the report back data.

The second portion of the report back message consists of the subscriber's current credit/debit status and includes the authentication data. Once the headend controller receives the current credit/debit values, it will send the television terminal security sub-system updated credit values, thus maintaining an adequate credit balance in the security sub-system for the subscriber.

In an internal (i.e. embedded) CAS television terminal, the current credit and debit values are retrieved by the terminal from the security sub-system at the time the report back message is constructed by the terminal.

In an external CAS television terminal such as those employing smart cards, a problem arises in that smart cards may be replaced. In any smart card capable host terminal, the system operator may replace the old smart card with a new smart card. Until the new smart card receives the proper security information from the headend controller, the new smart card will not be able to supply proper authentication data to validate purchases, which the host may be holding, that were made under the old smart card. To extend this idea, when the host terminal receives a purchase poll command, it may be holding purchases made under both the old and the new smart cards.

Also, when a smart card is inserted into a smart card capable host terminal for use with a new consumer, it may be holding “stale” credit/debit values left over from a previous usage (a previous subscriber). The headend controller must retrieve the stale debit values (but with proper authentication data to verify the smart card and its data) before the headend controller can update the smart card's credit values for use in the new host terminal. Before the host terminal can retrieve the stale debit values, the headend controller must first supply the smart card with the security information required to compute the authentication data.

Examples of external CAS systems using smart cards can be found, for example, in U.S. Pat. No. 5,144,664 to Esserman, et al., entitled “Apparatus and Method for Upgrading Terminals to Maintain A Secure Communication Network” and U.S. Pat. No. 5,111,504 to Esserman, et al., entitled “Information Processing Apparatus With Replaceable Security Element.”

The present invention is designed to handle the case where a previously used smart card is re-issued to a consumer without the IPPV values on the card being zeroed out by the system operator. As additional processing requirements are necessary for the system operator to zero out a card each time it is reissued and there is no guarantee that the system operator will zero out every card before it is re-issued, it is advantageous to account for re-issued cards with stale IPPV values automatically at the terminal.

In addition, in certain cable systems, such as those developed by General Instrument Corporation the assignee of the present invention, smart cards must be mated to their current host terminal, ensuring that, once mated, the smart card will function with no other host terminal. Likewise, the host terminal will function with no other smart card. Smart card mating involves a secure exchange of encryption/decryption keys between the controller and the smart card via the host terminal.

It would be advantageous to provide methods and apparatus for managing and updating smart card IPPV data in cable systems once the smart card is mated to the terminal, enabling new and/or reissued smart cards to be used in the cable system. It would be further advantageous to provide methods and apparatus to enable the host terminal to properly build purchase poll report back messages when two or more external security sub-systems (smart cards) may be supplying authentication data. It would be further advantageous to provide a new or re-issued smart card with the security information needed to compute authentication data, as the Smart Card must supply authentication data when reporting purchases in response to purchase polls from the headend controller. It would be still further advantageous to provide the headend controller with a mechanism for updating a smart card's “stale” credit values.

The methods and apparatus of the present invention provide the foregoing and other advantages.

### SUMMARY OF THE INVENTION

The present invention relates to methods and apparatus for managing and collecting impulse pay-per-view (IPPV) data in smart card enabled digital consumer television terminals. The present invention includes a headend controller, a smart card enabled television terminal in communication with the controller via a network, and a smart card operatively associated with the terminal. The controller sends security information to the terminal for use by the smart card. Authentication data based on the security information is computed by the smart card. The terminal is polled by the headend controller to retrieve the authentication data and current IPPV data from the smart card. The current IPPV data is validated by the controller based on the authentication data. Upon validation of the current IPPV data, updated IPPV data is computed and sent from the controller to the smart card via the terminal.

The present invention also enables a purchase report back message to be constructed at the terminal at the time of an initial IPPV purchase, rather than at the time of the poll from the controller. The purchase report back message may be updated at the time of each subsequent IPPV purchase after the initial purchase. The headend controller periodically polls the terminal to retrieve the report back message. The purchase report back message is overwritten with a new purchase report back message at the time of a first IPPV purchase occurring after each poll.

### BRIEF DESCRIPTION OF THE DRAWINGS

The present invention will hereinafter be described in conjunction with the appended drawing figures, wherein like numerals denote like elements, and:

FIG. 1 shows a block diagram of an exemplary embodiment of the invention; and

FIG. 2 shows a block diagram of a further embodiment of the invention.

### DETAILED DESCRIPTION OF THE INVENTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing a preferred embodiment of the invention. It should be understood that various changes may be made in the function and arrangement of elements without departing from the spirit and scope of the invention as set forth in the appended claims.

The present invention enables the following functions:

A. Providing the smart card with the security information it needs to compute authentication values: updating the smart card's IPPV data: The controller will: (a) send to the host terminal the security information the smart card needs to compute authentication data; (b) purchase poll the host terminal to retrieve the smart card's current IPPV data and the corresponding authentication data; (c) validate the current IPPV data based on the authentication data; and (d) if validation occurs (i.e. if the message is verified as coming from the appropriate smart card), send the smart card updated IPPV values, which are based on the authenticated current IPPV values. These steps may be performed as part of the mate operation in terminals where the smart card must be mated to the terminal.

B. Storing initial smart card credit/debit data in the host terminal: Since a smart card can be removed/replaced at any moment, the host terminal, upon detecting that a new smart card has been inserted and needs to be mated, will store the smart card's initial, non-updated credit/debit values and applicable authentication data as part of the mate operation (but not until the smart card has received its security information). Purchase data for previously mated smart cards may not be deleted or overwritten until that information has been reported to the headend controller. The host terminal will perform this task each time a smart card is mated to it.

C. Building a complete purchase report back message at each purchase, rather than at time of poll: Since a smart card can be replaced or pulled out at any moment, the host terminal will build and store an entire purchase poll report back message data structure at the time of each IPPV purchase successfully ordered by the subscriber. The report back data structure will contain both purchase data and authenticated credit/debit status information. The host terminal will construct this data structure by adding data for the current purchase to the purchase data portion of the report back and updating the current credit/debit status portion of the report back with current values retrieved from the smart card. The authenticated credit/debit status information for the update should also reflect the purchase currently being granted.

It should be appreciated that, although the invention is described in connection with a cable system wherein the smart cards are mated to the terminals, the invention is not limited to such terminals, and can be implemented in any smart card enabled terminal, or other devise, where more than one smart card may be used. Similarly, those skilled in the art will appreciate that the present invention, although described in connection with IPPV purchases, may be extended to other types of smart card purchases enabled via a conditional access system, without deviating from the scope of the invention. Such purchases may include, for example, any type of pay-per-use purchase enabled via a smart card, such as Internet usage, telephone calls, program and file downloads, streaming media, on-line shopping, and the like.

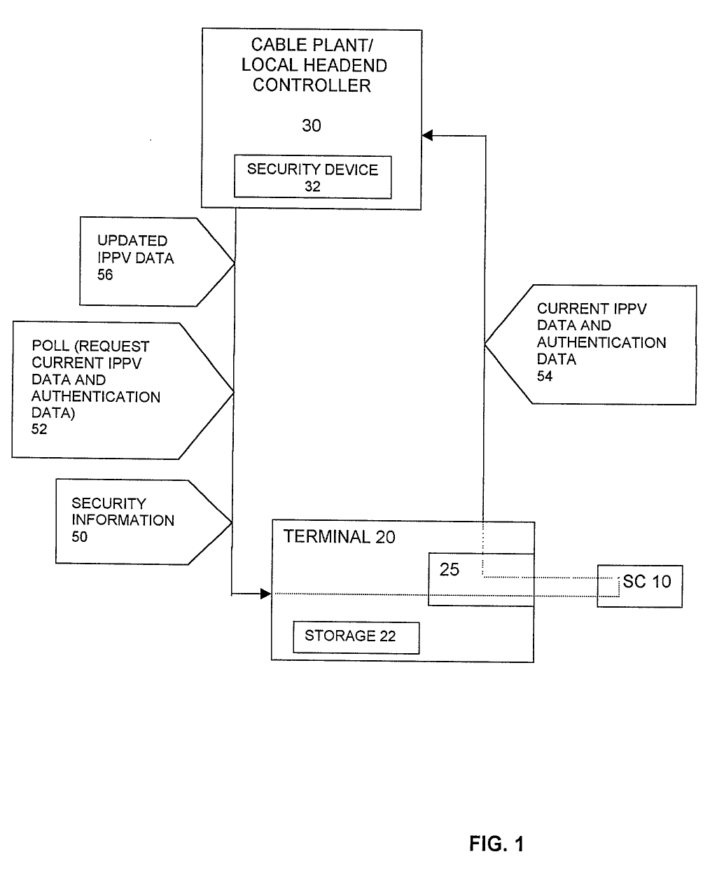

In an exemplary embodiment of the invention, methods and apparatus for the management and collection of impulse pay-per-view (IPPV) data are provided. As shown in FIG. 1, the present invention includes a headend controller 30, a smart card enabled digital television terminal 20 in communication with the controller 30 via a network, and a smart card 10 operatively associated with the terminal 20 (e.g., via interface 25). The controller 30 sends security information (shown as message 50) to the smart card 10 via the terminal 20. Authentication data based on the security information 50 is computed by the smart card 10. The terminal 20 is polled (shown as message 52) by the headend controller 30 to retrieve the authentication data and current IPPV data from the smart card 10. In response to the poll 52, the terminal 20 sends the current IPPV data and the authentication data (shown collectively as message 54) to the controller 30. The current IPPV data is validated by the controller 30 based on the authentication data. Upon validation of the current IPPV data, updated IPPV data (shown as message 56) is sent from the controller 30 to the smart card 10 via the terminal 20.

The security information sent from the controller 30 to the terminal 20 for use by the smart card 10 may comprise conditional access codes and decryption keys as described, for example, in U.S. Pat. No. 4,613,901 to Gilhousen, et al., U.S. Pat. No. 4,712,238 to Gilhousen, et al., U.S. Pat. No. 4,792,973 to Gilhousen, et al., and commonly owned U.S. Pat. No. 5,111,504 to Esserman, et al. Those skilled in the art will appreciate that various forms of conditional access systems may be used in implementing the present invention, with various types of security information. The exact nature and type of conditional access system and the corresponding security information used is not critical to the present invention.

The authentication data may be derived from at least one of the security information, the IPPV data and IPPV purchase record information using the security information sent from the controller 30. The updated IPPV data is based on the validated current IPPV data.

The smart card 10 may be a newly issued smart card with zero IPPV data values, a re-issued smart card with zero IPPV data values, or a re-issued smart card with non-zero IPPV data values.

Those skilled in the art will appreciate that the smart card enabled digital television terminal may comprise a set-top terminal associated with a television, a digital television having smart card capabilities, a personal computer having smart card capabilities and associated with a television and/or incorporating a television tuner, or the like. Alternately, the smart card enabled television terminal may comprise a stand-alone smart card device associated with either a set-top box, a television, a personal computer, or the like.

The terminal's IPPV capabilities may be temporarily disabled until updated IPPV data is received by the terminal 20. For example, when the controller 30 sends the security information to the terminal 20, it may also send a zero IPPV credit value, making it impossible for a subscriber to initiate an IPPV purchase. Other methods of temporarily disabling IPPV capabilities may also be implemented without impacting the present invention.

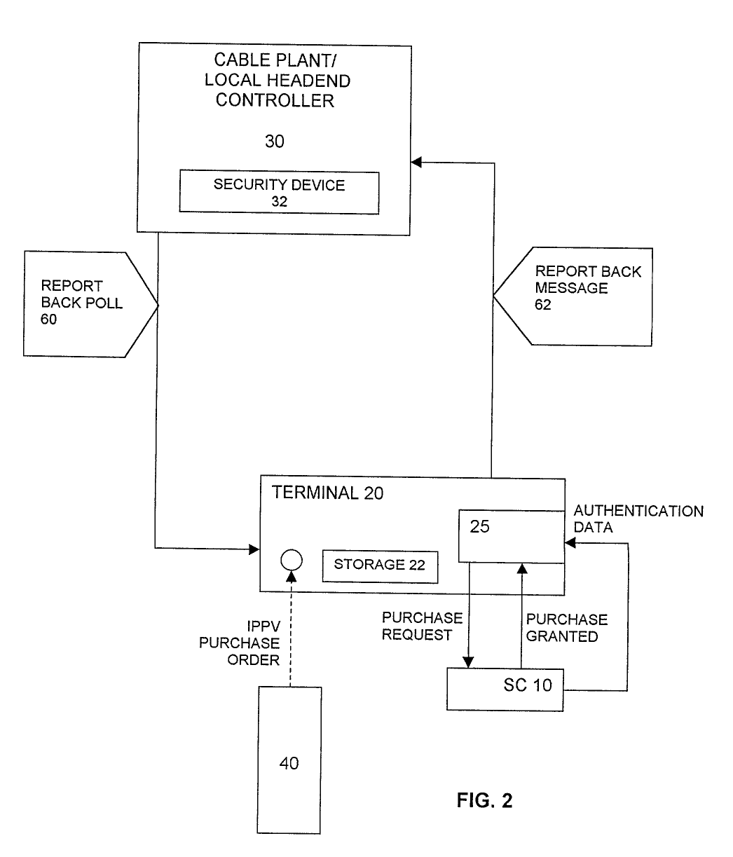

As shown in FIG. 2, when a subscriber makes an IPPV purchase request (e.g., via remote control 40), the updated IPPV data is compared to an IPPV purchase amount to determine whether to allow or disallow the IPPV purchase. For example, as shown in FIG. 2, the IPPV order is sent to the terminal 20 by the subscriber via the remote control 40. The purchase request is sent to the smart card 10 by the terminal 20, where the updated IPPV data is compared to the requested IPPV purchase amount. If the IPPV purchase amount is within the available credit on the smart card 10 as indicated by the updated IPPV data, the IPPV purchase is granted, otherwise, the purchase request is disallowed.

It should be appreciated by those skilled in the art that the IPPV data discussed in the present application can include, for example, a current credit value, a debit value, a show stack value, a show stack limit value, and the like. A current credit value may be based on a maximum value a system operator assigns to a subscriber. The debit value indicates the amount of credits used to date. The credit available for an IPPV purchase is then determined by subtracting the debit value from the credit value. The show stack value is a value indicating the number of programs ordered. The show stack limit value relates to the number of programs a subscriber is allowed to order. Once the show stack value equals the show stack limit value, IPPV purchases will be disallowed until the IPPV data, including show stack limit and show stack value, are updated by the controller 30. In addition, an IPPV purchase request which has a purchase value in excess of the difference between the credit and debit values will be disallowed. If the available credit and the show stack limit are not exceeded, the IPPV purchase will be allowed. The debit value and show stack value will then be updated accordingly. The debit values and show stack limit values may be increase only values, as only the difference between the debit and credit values and between the show stack and show stack limit values are relevant to allowing or disallowing IPPV purchases.

A storage device 22 associated with the terminal 20 may be provided for storing the current IPPV data. Previously stored IPPV data values from a prior smart card associated with the terminal 10 may be reported from the terminal 20 to the headend 30. Preferably, this previously stored IPPV data values will not be deleted or overwritten with the current IPPV data until the previously stored IPPV data values are reported to the headend 30.

In a further embodiment of the invention, a purchase report back message is constructed at the terminal 20 at the time of an initial IPPV purchase. The purchase report back message may be updated at the time of each subsequent IPPV purchase after the initial purchase. In this embodiment, the headend controller 30 periodically polls the terminal 20 (shown as report back poll message 60) to retrieve the report back message, which is sent from the terminal 20 (shown as report back message 62). The purchase report back message 62 is overwritten with a new purchase report back message at the time of a first IPPV purchase occurring after each poll 60. The purchase report back message 62 may be stored at the terminal 20, e.g., at storage device 22. The purchase report back message 62 may include at least one of the current IPPV data, IPPV purchase data, and the authentication data. The report back system of the present invention differs from prior art systems in that the report back message 62 is constructed at the time of the IPPV purchase, and updated for each subsequent purchase, rather than being constructed at the time of the poll as in prior art systems. In this manner, the present invention can accommodate systems where different smart cards may be mated and used with the same terminal, without losing purchase data.

For example, when the report back message 62 is built, the smart card 10 is asked to compute authentication values, based on the current IPPV data and the security information stored in the smart card. When the controller 30 gets the message, it sends the message to security device 32 in the headend which performs the same function as the smart card, meaning that the security device 32 at the controller computes the authentication values based on the current IPPV data and the security information just as the smart card did. If the headend security device 32 computes the same authentication values as the smart card 10 did (and the same authentication values that were returned in the report back message 62 to the controller 30), then the controller 30 considers the report back message to be valid and authenticated (which just means that, yes, the message 62 really came from the card that it claims to have come from). If the message 62 is valid, the controller 30 accepts the data in it. If the data is accepted, the controller looks at the current IPPV data and determines whether it needs to “update” the smart card's current IPPV data. If so, updated IPPV data is sent to the card as discussed above in connection with FIG. 1 (e.g., message 56).

The smart card 10 may include a power supply (e.g., a battery) as well as a security chip, to enable storage of the IPPV data when the card is not in use. Such a card can then draw power from the terminal 20 when inserted.

It should now be appreciated that the present invention provides advantageous methods and apparatus for managing and collecting IPPV data in smart card enabled digital television terminals.

Although the invention has been described in connection with various illustrated embodiments, numerous modifications and adaptations may be made thereto without departing from the spirit and scope of the invention as set forth in the claims.

What is claimed is:

1. A method for management and collection of impulse pay-per-view (IPPV) data in smart card enabled digital television terminals, comprising the steps of:
sending security information from a headend controller to a smart card via the terminal;
computing smart card authentication data based on said security information;
polling the terminal by the headend controller to retrieve said authentication data and current IPPV data;
validating said current IPPV data at said controller based on said authentication data; and
sending updated IPPV data from said controller to said smart card via said terminal.

2. A method in accordance with claim 1, wherein said authentication data is derived from at least one of:
said security information,
said IPPV data,
purchase record information.

3. A method in accordance with claim 1, wherein said updated IPPV data is based on said validated current IPPV data.

4. A method in accordance with claim 1, wherein said smart card is one of:
a newly issued smart card with zero IPPV data values,
a re-issued smart card with zero IPPV data values,
a re-issued smart card with non-zero IPPV data values.

5. A method in accordance with claim 1, further comprising:
temporarily disabling IPPV capabilities at the terminal until updated IPPV data is received by the terminal.

6. A method in accordance with claim 1, further comprising:
comparing the updated IPPV data to an IPPV purchase amount to determine whether to allow or disallow an IPPV purchase.

7. A method in accordance with claim 1, further comprising:
storing said current IPPV data at said terminal.

8. A method in accordance with claim 1, further comprising:
reporting previously stored IPPV data values from a prior smart card associated with said terminal from said terminal to said headend.

9. A method in accordance with claim 1, further comprising:
constructing a purchase report back message at said terminal at the time of an initial IPPV purchase.

10. A method in accordance with claim 9, further comprising:
updating said purchase report back message at the time of each subsequent IPPV purchase after said initial purchase.

11. A method in accordance with claim 10, further comprising:
periodically polling the terminal by the headend controller to retrieve the report back message.

12. A method in accordance with claim 11, further comprising:
overwriting said purchase report back message with a new purchase report back message at the time of a first IPPV purchase occurring after said polling.

13. A method in accordance with claim 9, further comprising:
storing said purchase report back message at said terminal.

14. A method in accordance with claim 9, wherein said purchase report back message includes at least one of said current IPPV data, IPPV purchase data, and said authentication data.

15. A system for management and collection of impulse pay-per-view (IPPV) data, comprising:
a headend controller;
a smart card enabled digital television terminal in communication with said controller via a network; and
a smart card operatively associated with said terminal;
wherein:
said controller sends security information to the smart card via the terminal;
authentication data based on said security information is computed by said
smart card;
the terminal is polled by the headend controller to retrieve said authentication data and current IPPV data;
said current IPPV data is validated by the controller based on said authentication data; and
updated IPPV data is sent from said controller to said smart card via said terminal.

16. A system in accordance with claim 15, wherein said authentication data is derived from at least one of:
said security information,
said IPPV data,
purchase record information.

17. A system in accordance with claim 15, wherein said updated IPPV data is based on said validated current IPPV data.

18. A system in accordance with claim 15, wherein said smart card is one of:
a newly issued smart card with zero IPPV data values,
a re-issued smart card with zero IPPV data values,
a re-issued smart card with non-zero IPPV data values.

19. A system in accordance with claim 15, wherein:
temporarily disabling IPPV capabilities at the terminal until updated IPPV data is received by the terminal.

20. A system in accordance with claim 15, wherein:
updated IPPV data is compared to an IPPV purchase amount to determine whether to allow or disallow an IPPV purchase.

21. A system in accordance with claim 15, further comprising:
a storage device associated with said terminal for storing said current IPPV data.

22. A system in accordance with claim 15, wherein:
previously stored IPPV data values from a prior smart card associated with said terminal are reported from said terminal to said headend.

23. A system in accordance with claim 15, wherein:
a purchase report back message is constructed at said terminal at the time of an initial IPPV purchase.

24. A system in accordance with claim 23, wherein said purchase report back message is updated at the time of each subsequent IPPV purchase after said initial purchase.

25. A system in accordance with claim 24, wherein:
the headend controller periodically polls the terminal to retrieve the report back message.

26. A system in accordance with claim 25, wherein said purchase report back message is overwritten with a new purchase report back message at the time of a first IPPV purchase occurring after said poll.

27. A system in accordance with claim 23, wherein said purchase report back message is stored at said terminal.

28. A system in accordance with claim 23, wherein said purchase report back message includes at least one of said current IPPV data, IPPV purchase data, and said authentication data.

29. A method for managing and collecting impulse pay-per-view (IPPV) data in smart card enabled digital television terminals, comprising the steps of:
constructing a purchase report back message at a television terminal at the time of an initial IPPV purchase;
updating said purchase report back message at the time of each subsequent IPPV purchase; and
periodically polling said terminal by a headend controller to retrieve the purchase report back message.

30. A method in accordance with claim 29, further comprising:
overwriting said purchase report back message with a new purchase report back message at the time of a first IPPV purchase occurring after said polling.

31. A method in accordance with claim 29, further comprising:
storing said purchase report back message at said terminal.

32. A method in accordance with claim 29, wherein said purchase report back message includes at least one of said current IPPV data, IPPV purchase data, and said authentication data.

33. A system for managing and collecting impulse pay-per-view (IPPV) data in smart card enabled digital television terminals, comprising:
a headend controller;
a smart card enabled digital television terminal in communication with said controller via a network; and
a smart card operatively associated with said terminal;
wherein:
a purchase report back message is constructed at said television terminal at the time of an initial IPPV purchase;
said purchase report back message is updated by said terminal at the time of each subsequent IPPV purchase; and
said terminal is periodically polled by a headend controller to retrieve the purchase report back message.

34. A system in accordance with claim 33, wherein:
said purchase report back message is overwritten with a new purchase report back message at the time of a first IPPV purchase occurring after said polling.

35. A system in accordance with claim 33, wherein:
said purchase report back message is stored at said terminal.

36. A system in accordance with claim 33, wherein said purchase report back message includes at least one of said current IPPV data, IPPV purchase data, and said authentication data.
